(19) United States
(12) Patent Application Publication
(10) Pub. No.: US 2010/0002190 A1
(43) Pub. Date: Jan. 7, 2010

(54) ELECTRICAL INSULATING LAYERS, UV PROTECTION, AND VOLTAGE SPIKING FOR ELECTRO-ACTIVE DIFFRACTIVE OPTICS

(76) Inventors: Roger CLARKE, Melbourne (GB); William Kokonaski, Gig Harbor, WA (US); Joshua N. Haddock, Roanoke, VA (US); Venkatramani S. Iyer, Roanoke, VA (US)

Correspondence Address: Townsend and Townsend and Crew LLP, Two Embarcadero Center, Eighth Floor, San Francisco, CA, 94111-3834, US

(21) Appl. No.: 12/042,643

(22) Filed: Mar. 5, 2008

Related U.S. Application Data
(60) Provisional application No. 60/906,211, filed on Mar. 12, 2007.
(60) Provisional application No. 60/971,308, filed on Sep. 11, 2007.
(60) Provisional application No. 60/974,504, filed on Sep. 24, 2007.

(51) Int. Cl. G02C 7/06; G02F 1/29; G02F 1/1335

(52) U.S. Cl. 351/168; 359/319; 349/200

(57) ABSTRACT

An electro-active lens has a first substrate with a surface relief diffractive topological profile and a second substrate positioned opposite to the first substrate having a substantially smooth topological profile. A first electrode is positioned along the surface relief diffractive topological profile of the first substrate and a second electrode is positioned between the first electrode and the second substrate. The smallest distance between the electrodes is less than or equal to about 1 micron An electro-active material is positioned between the first and second electrodes and a first insulating layer is positioned between the first and second electrodes.

### CROSS REFERENCE TO RELATED APPLICATIONS

This application claims priority from and incorporates by reference in their entirety the following U.S. provisional applications:
U.S. Provisional Application Ser. Nos. 60/906,211, filed on 12 Mar. 2007 and 60/971,308, filed on 11 Sep. 2007, both entitled “Electrical Insulating Layers, UV Protection, and Voltage Spiking for Electro-Active Diffractive Optics” and U.S. Provisional Application Ser. No. 60/974,504, filed on 24 Sep. 2007 entitled, “Electro-active Diffractive Lens With Self Regulated Thickness of Electro-active Material.

### FIELD OF THE INVENTION

The present invention relates to reducing the thickness of an electro-active element in an ophthalmic lens while preventing electrical conduction between electrodes by providing insulating material between electrodes.

### BACKGROUND OF THE INVENTION

An electro-active lens is a device that has alterable optical properties, such as focal length, opacity, etc. The alterable optical properties are provided, in part, by having electro-active material in the lens. Typically, an electro-active lens has the electro-active material disposed between electrodes. When an electrical potential is applied between the electrodes of the electro-active material an electric field is generated. The orientation of molecules in the electro-active material determines optical properties of the material. The molecules of the electro-active material, on average, orient in relation to the applied electric field. In this way, the optical properties of the electro-active material may be altered.

One way of producing an electro-active lens is to provide electro-active material in combination with a diffractive optic. In such a case, a portion of the lens has electro-active material overlying a surface relief diffractive topological profile. Such a lens typically has one substrate having a surface relief diffractive topology and another substrate having a substantially smooth surface facing the surface relief side. The electro-active material is typically interposed between the two substrates. The substrates are covered with one or more transparent electrodes. In the absence of electrical energy the index of refraction of the electro-active material substantially matches the index of refraction of the surface relief diffractive profile. Such matching results in a canceling out of the optical power of the diffractive optic. The application of electrical energy between the electrodes causes the index of refraction of the electro-active material to differ from that of the surface relief diffractive profile so as to create a condition for incident light to be diffracted (i.e. focused) with high efficiency.

Using electro-active material, however, presents problems. One problem is that the switching times between different states of the electro-active material is quadratic with respect to the material's thickness. Therefore, it is desirable to have an electro-active layer as thin as possible.

However, by narrowing the substrate gap a new problem arose. The voltage potential is applied to the electro-active material by having two electrodes adjacent to both sides of the electro-active material. Each of the electrodes is typically designed to conform to the shape of an opposite inner surface of one of the substrates. Thus, the gap between the electrodes is narrowed when the substrates are pushed closer together. This increases the probability for the electrodes to conduct (e.g., short circuit, arc discharge, or otherwise malfunction).

In particular, the electrode that conforms to the surface relief diffractive topography forms peaks that extend substantially close to the opposite electrode. At least one of these peaks may create a smallest distance between the electrodes at which the electrodes may conduct due to their proximity. Such conductance will result in a malfunction.

To minimize such malfunction, electro-active lenses were manufactured having a substantial gap between the electrodes. The gap is typically sized for sufficiently preventing the electrodes from conducting while enabling the electrodes to provide the desired electric field. Typically, the gap in the lenses is manufactured by placing a constant spacer, for example, glass beads, between the two substrates. The spacer separates the electrodes. However, spacing the substrates increases the thickness of the region of the electro-active material (e.g., by at least 10 micrometers, microns, (μm)), thus increasing the switching time between the states of the electro-active material. Creating such a gap may also result in requiring additional power to maintain the requisite potential.

To avoid such electrical malfunctions, the electrodes of conventional lenses are taught to be separated by a substantially large gap. For example, U.S. Pat. No. 4,904,063 to Okada uses a gap of at least 10 microns. Spacers, such as glass beads were used, to provide for this relatively substantial gap.

There is therefore a great need in the art for reducing the thickness of electro-active material while minimizing electrical malfunction caused by the resulting narrowing gap between the electrodes. Accordingly, there is now provided with this invention an improved electro-active lens for effectively overcoming the aforementioned difficulties and longstanding problems inherent in the art.

### SUMMARY OF THE INVENTION

In one embodiment of the present invention an electro-active lens has a first substrate having a surface relief diffractive topological profile and a second substrate positioned opposite to the first substrate facing the surface relief diffractive topological profile. The second substrate has a substantially smooth topological profile. A first electrode is positioned along the surface relief diffractive topological profile of the first substrate and a second electrode is positioned between the first electrode and the second substrate. The smallest distance between the electrodes is less than or equal to about 1 micron. Electro-active material is positioned between the first and second electrodes and a first insulating layer is positioned between the first and second electrodes.

In another embodiment of the present invention an electro-active lens has a first substrate having a surface relief diffractive topological profile and a second substrate having a substantially smooth topological profile positioned facing the surface relief diffractive topological profile. A first electrode is positioned along the surface relief diffractive topological profile of the first substrate and a second electrode is positioned between the first electrode and the second substrate. Electro-active material is positioned between the first and second electrodes. A first insulating layer having a thickness less than or equal to about 1 micron is positioned between the first and second electrodes.

In another embodiment of the present invention an electro-active lens has a first substrate having a surface relief diffractive topological profile forming a plurality of peaks. A second substrate having a substantially smooth topological profile is positioned facing the surface relief diffractive topological profile. A first electrode and a second electrode is disposed between the substrates following the topological profiles of the first and second substrates, respectively. The electrodes form a gap between the substrates narrowing at the peaks to a distance less than or equal to about 1 micron. Electro-active material having an alterable optical property is positioned between the first and second electrodes. A first insulating layer is disposed between the first and second electrodes, wherein the first insulating layer has an impedance sufficient for allowing an electrical potential to be applied to said electrodes for altering an optical property of the electro-active material and for preventing electrical conduction between said electrodes at the peaks.

The present invention will be better understood by reference to the following detailed discussion of specific embodiments and the attached figures, which illustrate and exemplify such embodiments.

### BRIEF DESCRIPTION OF THE DRAWINGS

Specific embodiments of the present invention will be described with reference to the following drawings, wherein:

FIG. 1 shows a schematic side view drawing of an electro-active lens according to an embodiment of the invention; and

FIG. 2 shows a schematic side view drawings of the electro-active lens having an insulating layer positioned between electrodes according to an embodiment of the invention.

FIG. 3 shows a schematic side view drawings of the electro-active lens having insulating layers positioned between electrodes according to an embodiment of the invention.

FIG. 4 shows a schematic side view drawings of the electro-active lens having insulating layers positioned between electrodes according to an embodiment of the invention.

FIG. 5 shows a schematic side view drawings of the electro-active lens having insulating layers positioned between electrodes according to an embodiment of the invention.

### DESCRIPTION OF THE PREFERRED EMBODIMENT

The following preferred embodiments as exemplified by the drawings are illustrative of the invention and are not intended to limit the invention as encompassed by the claims of this application.

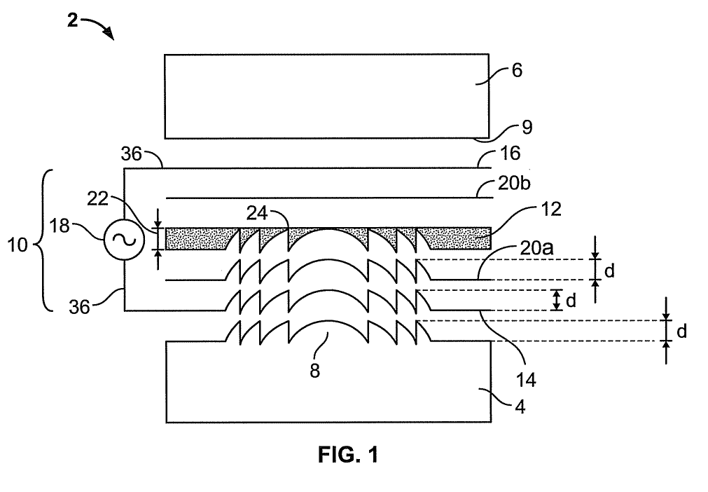

FIG. 1 shows a schematic side view drawing of an electro-active lens 2. The electro-active lens may include a first substrate 4 and a second substrate 6 positioned on opposite sides of the lens. The first substrate may have a surface relief diffractive topological profile 8 for diffracting light. The surface relief diffractive pattern may vary along a maximum thickness, d. The second substrate may have a substantially smooth topological profile 9. The smooth topological profile of substrate 6 faces the surface relief diffractive profile of substrate 4. Each of the substrates may have fixed optical properties, such as a refractive index (n) approximately equal to 1.67. The substrates may be composed of materials including, for example, A09 (manufactured by Brewer Science, having n=1.66) or alternatively the commercially available ophthalmic lens resin MR-10 (manufactured by Mitsui, having n=1.67).

The electro-active lens may include an electro-active element 10 positioned between the first and second substrates. The electro-active element 10 is preferably embedded therein. The first and second substrates may be shaped and sized to ensure that the electro-active element is contained within the substrates and that contents of the electro-active element cannot escape. The first and second substrates may also be curved such that they facilitate incorporation of the electro-active element into a spectacle lens, which are typically curved.

The electro-active element 10 includes one or more electrodes 14 and 16 positioned along the first and second substrates, respectively. One of the electrodes may act as a ground electrode and the other may act as a drive electrode. The electrodes may form continuous film layers conforming to the surfaces of their respective substrates. The electrodes may be optically transparent. The electrodes may, for example, include any of the known transparent conductive oxides (e.g., indium tin oxide (ITO)) or a conductive organic material (e.g., poly(3,4-ethylenedioxythiophene) poly(styrenesulfonate) (PEDOT:PSS) or carbon nano-tubes). The thickness of each of the electrodes may be, for example, less than 1 micron (μm) but is preferably less than 0.1 μm.

The electro-active lens typically should include drive electronics 18 including a controller and a power supply, for applying one or more voltages to each of the electrodes and for generating a voltage potential across the electrodes. The drive electronics are electrically connected to the electrodes by electrical connections 36. The electrical connections may include wires or traces, or the equivalent. Such connections may also be transparent.

The drive electronics apply voltage potentials to the electrodes having amplitude in a range of from approximately 6 volts to approximately 20 volts. The voltage potentials should be sufficient for forming an electric field across the electro-active material yet insufficient for the electrodes to conduct. The drive electronics may apply either alternating current (AC) or direct current (DC) to the electrodes.

The lens has electro-active material 12 positioned between the first and second electrodes. When sufficient electrical potential is applied to the electro-active material, the index of refraction of the electro-active material is altered. Such alteration of the index of refraction of the electro-active material results in a change of an optical property of the electro-active lens. For example, the focal length or the diffraction efficiency of the lens may be preferentially changed in a predetermined way.

The electro-active material 12 may include a liquid crystalline material, preferably a cholesteric liquid crystalline material. The cholesteric liquid crystalline material has a refractive index that changes between an average refractive index, n_{avg} (e.g., approximately equal to 1.67) when no electrical potential is applied, and an ordinary refractive index, nₒ (e.g., approximately equal to 1.52) when sufficient electrical potential is applied. Other intermediate refractive indices, n, where nₒ<n<n_{avg}, may be achieved when intermediate electrical potentials are applied to the cholesteric liquid crystalline material. The cholesteric liquid crystalline material may allow for the focusing of light having substantially any polarization state and is thereby termed, “polarization insensitive”, as is described in further detail in U.S. Ser. No. 12/018,048, filed on 22 Jan. 2008, entitled “Cholesteric Liquid Crystalline Material”, which is incorporated herein by reference in its entirety.

The electro-active material may exhibit hysteresis (changing between states depends not only on the input but on the prior state). Thus, the material may require a first applied voltage potential to initially switch to a first state, but may only require a smaller second voltage potential to maintain this state. Thus, the drive electronics may apply voltage across the electrodes using a first voltage potential, which may be followed by a sustained second relatively smaller voltage potential. Because electro-active material exhibits hysteresis, the overall electrical power potential applied across the electrodes for operating the lens may be reduced.

For example, the cholesteric liquid crystalline material may require an electrical potential of 10 volts to initially switch from an average refractive index, n_{avg}, to an ordinary refractive index, nₒ, but may only require an electrical potential of 7 volts to maintain the ordinary refractive index, nₒ. It is known that electrical power for operating the lens may be approximately CV²f/2, where C is the capacitance of the layer of cholesteric liquid crystalline material, f is the frequency of an applied alternating current (AC) voltage potential, and V is the amplitude of the applied voltage potential. Thus, for a given C and f, reducing the amplitude of the applied voltage potential, V, from 10 volts to 7 volts reduces the electrical power consumption by a factor of approximately 2. The lens includes alignment layers 20a and 20b positioned between the electro-active material and the electrodes 14 and 16, respectively. Alignment layer 20a is shown as following the topological profile of electrode 14. The alignment layer 20b is shown following the topological profile of electrode 16. The lens may alternatively include only a single alignment layer.

The alignment layers 20a and 20b are typically thin films, for example, each alignment layer may be less than 100 nanometers (μm). Alignment layers 20a and 20b are preferably less than 50 nm thick. The alignment layers are preferably constructed, for example, from a polyimide material. The alignment layers are typically buffed in a single direction (the alignment direction) with a cloth such as velvet. When the molecules of the electro-active material come in contact with the buffed polyimide layer, the molecules preferentially lie in the plane of the substrate and are aligned in the direction in which the alignment layers were rubbed. Alternatively, the alignment layers may be constructed of a photosensitive material, which when exposed to linearly polarized ultraviolet (UV) light, yield the same result as when buffed alignment layers are used.

The refractive index, n_{avg}, of the electro-active material (e.g., n_{avg}=1.67 for cholesteric liquid crystalline material) is preferably matched with the refractive index of the substrates (e.g., fixed at approximately 1.67) when no electrical potential is applied. However, when an electrical potential is applied above a predetermined threshold, the refractive index, nₒ, of the electro-active material (e.g., nₒ=1.52 for cholesteric liquid crystalline material) is altered from that of the refractive index of the substrates.

This change in the refractive index of the electro-active material from the refractive index of the substrate to the new refractive index (the difference between nₒ and n_{sub}) results in a retardation of the optical wave which is generated over the extent of the electro-active material. This retardation is equal to d(n_{sub}−nₒ). For maximum diffraction efficiency (the fraction of incident light that will be brought to focus using the diffractive element), it is necessary that all incident light of a wavelength [symbol] interfere constructively at the focal point, where λ is the wavelength of light for which the electro-active element is designed to focus (e.g., 550 nm). This is typically referred to as the “design” wavelength of the lens. For constructive interference to occur, the light must be in phase at the focal point. When the optical retardation over each diffractive zone is an integer multiple of λ (equivalent to an integer multiples of a 2π phase delay), all the light will be in phase at the focal point, interfere constructively, and the electro-active element will have a high diffraction efficiency.

However, the problem in the art is that these retardations are achieved over very short distances (typically less than 50 micrometers) and using such a small distance between electrodes causes the aforementioned electrical malfunctions to occur.

The present invention solves this problem. In the present invention, the electrode 16 follows the substantially smooth topological profile 9 of the second substrate and the electrode 14 follows the surface relief diffractive topological profile 8 of the first substrate. Thus, the electrode 14 conforms to the surface relief diffractive pattern. The electrode 14 forms peaks that extend towards the opposite electrode 16 closing the distance therebetween. In certain embodiments of the invention, the height of the surface relief diffractive structure acts to set and control the thickness of the electro-active material.

Thus, the distance between the opposite electrodes varies between a relatively large distance 22 having thickness of at least d, and a smallest distance 24 (e.g., at one or more of the phase wrap points), formed at the highest point(s) of the surface relief diffractive topography. In the prior art, the smallest distance may be so small (e.g., less than about 1 micron) that when an electrical potential is applied to the electrodes, the electrodes conduct and a current jumps therebetween. This results in a short circuit or arc discharge (electrical arcing) across the electrodes. Such electrical conduction may be operatively destructive to the electro-active lens either immediately or over time depending on the degree of the malfunctions.

To solve this problem, the lenses described herein use insulating layers to provide the necessary impedance for minimizing the aforementioned electrical malfunctions.

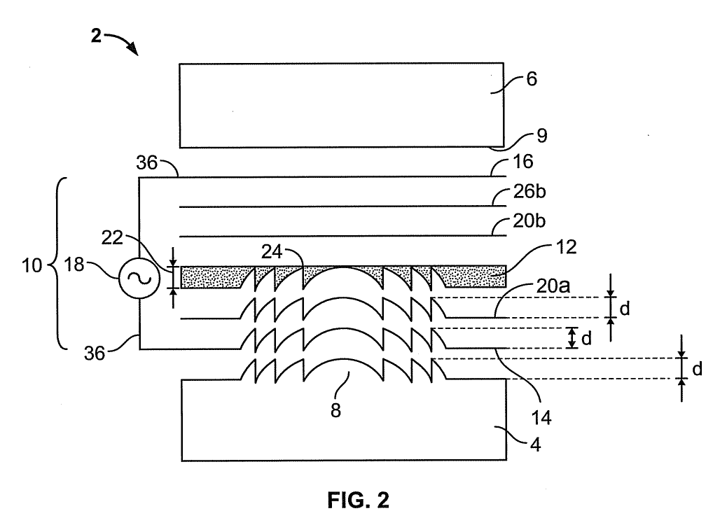

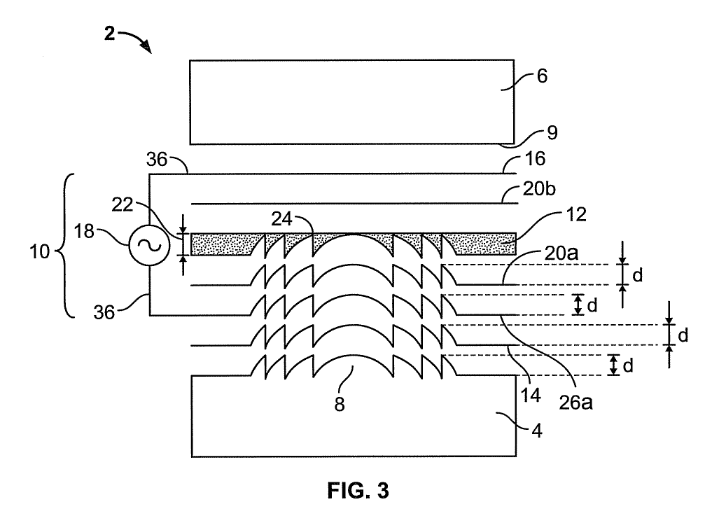

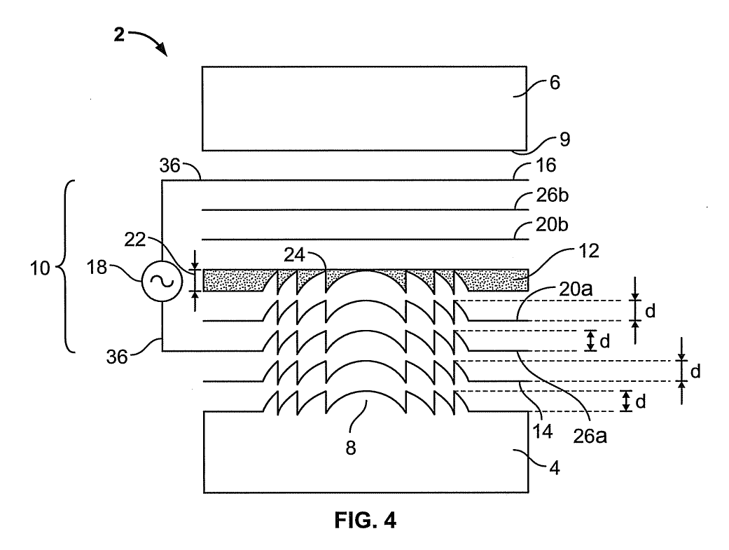

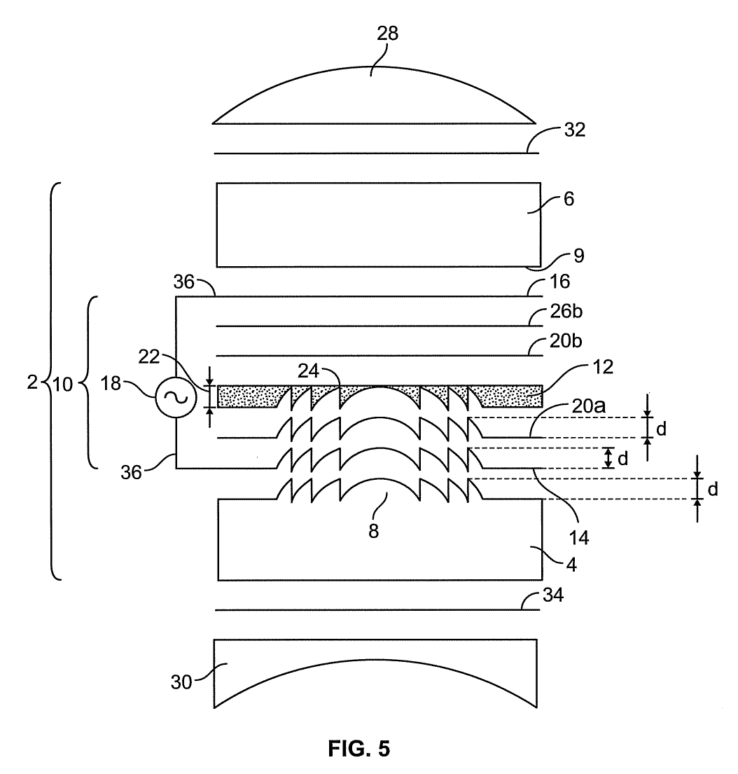

FIG. 2, FIG. 3, FIG. 4, and FIG. 5, show schematic side view drawings of the electro-active lens 2 having one or more insulating layers 26a and/or 26b positioned between the electrodes 14 and 16 according to an embodiment of the invention. FIG. 2 and FIG. 5 show insulating layer 26b positioned along the electrode 16 following the topological profile thereof (thereby having a smooth shape). FIG. 3 shows insulating layer 26a positioned along the electrode 14 following the topological profile thereof (thereby having a shape that varies along the surface relief diffractive topological profile 8). FIG. 4 shows insulating layers 26a and 26b, positioned along both of the electrodes 14 and 16, respectively. Additional insulating layers (not shown) may be placed between the electrodes. Additional layers, for example, adhesive layers, (not shown) may be placed between the electrodes and the insulating layers. By providing such insulating layers, the electrodes may be brought to a distance closer together than was achievable heretofore. Similarly, by providing insulating layers, spacers positioned for expanding a gap between the electrodes are eliminated.

The insulating layers 26a and 26b may comprise organic or inorganic dielectric materials, such as for example, SiO₂, SiO, Al₂O₃ and TiO₂ and organic materials such as PMMA, polycarbonate, acrylates, polyamides, polyimides, sulphones, and polysulphones. The insulating layer may be optically transparent for the wavelengths of light for which the lens is designed to focus (e.g., the “design” wavelength of the lens). The insulating layer may be, for example, preferably greater than about 100 nm thick but less than about 1 micron thick. The insulating layer may be sufficiently thick for preventing the electrodes from conducting while still maintaining the voltage potentials between the electrodes necessary for operating the lens.

The insulating layers 26a and 26b may also act as barriers to the incursion of volatile material from the substrates into the electro-active material. The substrate material may, over time and upon heating, release vapors (i.e. out-gas) that can cause undesireable bubbles or voids in the electro-active element. These vapors may contain, for example, one or more of water, oxygen, and organic solvents.

The impedance of the insulating layers should be greater than the impedance of the electro-active material. The insulating layer may have an impedance sufficient for enabling an electrical field to form across the electro-active material for altering the optical property thereof while preventing electrical conduction across the smallest distances of the electrodes. The insulating layers may increase the impedance between the electrodes for preventing the electrical conduction thereby.

The impedance for preventing electrical conduction between the electrodes, previously achieved in conventional lenses by spacing the electrodes, is provided herein by the insulating layers. Thus, the electrodes no longer need to be separated by spacers at the ends of the substrates. Since the insulating layers (e.g., 100 nm-1 micron thick) of the present invention are thinner than the spacers of conventional lenses (e.g., 10 microns thick) and allow for a thinner layer of electro-active material, an overall reduction in the thickness of the lens is achieved. This is because the impedance is provided by the insulating layer and by not having a thicker layer of electro-active material. The smallest distance 24 between the electrodes may now be in a range of from about 1 nm to about 1 micron. Other distances between the peaks of the surface relief electrode and the other smooth electrode may be less than about 10 microns. Switching time is also thereby reduced.

The lens is typically assembled by stacking the elements of the lens with substantially no space between each of the elements. Thus, the smallest distance between the electrodes may be about the total thickness of the intervening layers (e.g., insulating and/or alignment layers). For example, the smallest distance 24 in each of FIG. 2, FIG. 3, and FIG. 5 may be about the thickness of one insulating layer and two alignment layers. The smallest distance 24 in FIG. 4 may be about the thickness of two insulating layers and two alignment layers.

FIG. 5 shows the electro-active lens 2 of FIG. 2 positioned between a first and a second refractive optic 28 and 30 for refracting light. The electro-active lens is embedded within the first and second refractive optics. The lens includes adhesive layers 32 and 34 for securing the electro-active lens to the first and second refractive optics, respectively. Each of the first and second refractive optics and the adhesive layers may have refractive indices that match the average refractive index, n_{avg}, of the electro-active material (e.g., n_{avg}=1.67 for cholesteric liquid crystalline material).

The first and/or second refractive optics 28 and/or 30 may be adapted for blocking the transmission of UV electromagnetic radiation. The UV radiation is known to potentially damage some electro-active materials, materials used for the alignment layers, and materials used for the insulating layers (especially if the materials include organic compounds). The refractive optics may be formed from materials that inherently block such radiation. Alternately, the refractive optics may be coated or imbibed with additional material (not shown) for blocking the UV radiation. Such UV blocking materials are well known in the art and include, for example, UV Caplet II and UV crystal clear (available from Brain Power Inc. (BPI)).

What is claimed is:

1. An electro-active element housed in an ophthalmic lens, comprising:
a. a first electrode;
b. a second electrode spaced from said first electrode not more than 10 microns; and
c. electro-active material interposed between said electrodes,
wherein the ophthalmic lens has a first optical power when no electrical power is applied to said electrodes and said first optical power and a second optical power when electrical power is applied to said electrodes.

2. An electro-active lens, comprising:
a first substrate having a surface relief diffractive topological profile;
a second substrate positioned opposite to said first substrate, wherein said second substrate has a substantially smooth topological profile facing said surface relief diffractive topological profile;
a first electrode positioned along said surface relief diffractive topological profile of said first substrate;
a second electrode positioned between said first electrode and said second substrate, wherein the smallest distance between said electrodes is less than or equal to about 1 micron;
an electro-active material positioned between said first and second electrodes; and
a first insulating layer positioned between said first and second electrodes.

3. The lens of claim 2, further comprising a first alignment layer positioned between said electro-active material and at least one of said first and second electrodes.

4. The lens of claim 2, wherein the impedance of said insulating layer is greater than the impedance of said electro-active material.

5. The lens of claim 2, wherein the difference between the optical path length of light traveling between said electrodes through said smallest distance and a largest distance therebetween is approximately equal to the design wavelength of said lens.

6. The lens of claim 2, wherein said first insulating layer is positioned along said first electrode.

7. The lens of claim 2, wherein said first insulating layer is positioned along said second electrode.

8. The lens of claim 2, further comprising a second insulating layer disposed between said two electrodes, wherein said first insulating layer is positioned along said first electrode and said second insulating layer is positioned along said second electrode.

9. The lens of claim 3, further comprising a second alignment layer, wherein said first alignment layer is positioned between said electro-active material and said first electrode and said second alignment layer is positioned between said electro-active material and said second electrode.

10. The lens of claim 2, wherein said electro-active material has an alterable refractive index and each of said first and second substrates have a fixed refractive index, wherein when an electrical potential is applied below a first predetermined threshold between said first and second electrodes the refractive index of said electro-active material is approximately equal to the refractive index of said first and second substrates.

11. The lens of claim 10, wherein when an electrical potential is applied above a second predetermined threshold between said first and second electrodes the refractive index of said electro-active material is different from the refractive index of said first and second substrates.

12. The lens of claim 11, wherein said difference in refractive indices results in a phase retardation of approximately 2π.

13. The lens of claim 2, further comprising a static refractive optic, wherein said electro-active lens is embedded within said static refractive optic.

14. The lens of claim 13, further comprising adhesive for securing said electro-active lens within said static refractive optic.

15. The lens of claim 13, wherein said static refractive optic is adapted for blocking ultraviolet electromagnetic radiation.

16. The lens of claim 15, wherein said static refractive optic is formed from materials that block ultraviolet electromagnetic radiation.

17. The lens of claim 15, wherein said static refractive optic is coated with materials that block ultraviolet electromagnetic radiation.

18. The lens of claim 2, wherein said electro-active material is a cholesteric liquid crystal material.

19. The lens of claim 2, wherein when said electrical potential is applied between said first and second electrodes using an initial waveform spike in electrical potential at a first voltage followed by a sustained electrical potential waveform at a second relatively smaller voltage.

20. The lens of claim 2, wherein said insulating layer comprises SiO₂.

21. The lens of claim 2, wherein the insulating layer is sufficiently thick for preventing said electrodes from conducting and for maintaining voltage potentials between said electrodes for operating the lens.

22. An electro-active lens, comprising:
a first substrate having a surface relief diffractive topological profile;
a second substrate positioned opposite to said first substrate, wherein said second substrate has a substantially smooth topological profile facing said surface relief diffractive topological profile;
a first electrode positioned along said surface relief diffractive topological profile of said first substrate;
a second electrode positioned between said first electrode and said second substrate;
an electro-active material positioned between said first and second electrodes; and
a first insulating layer positioned between said first and second electrodes having a thickness less than or equal to about 1 micron.

23. The lens of claim 22, further comprising a first alignment layer positioned between said electro-active material and at least one of said first and second electrodes.

24. The lens of claim 22, wherein the impedance of said insulating layer is greater than the impedance of said electro-active material.

25. The lens of claim 22, wherein the difference between the optical path length of light traveling between said electrodes through said smallest distance and a largest distance therebetween is approximately equal to the design wavelength of said lens.

26. The lens of claim 22, wherein said first insulating layer is positioned along said first electrode.

27. The lens of claim 22, wherein said first insulating layer is positioned along said second electrode.

28. The lens of claim 22, further comprising a second insulating layer disposed between said two electrodes, wherein said first insulating layer is positioned along said first electrode and said second insulating layer is positioned along said second electrode.

29. The lens of claim 23, further comprising a second alignment layer, wherein said first alignment layer is positioned between said electro-active material and said first electrode and said second alignment layer is positioned between said electro-active material and said second electrode.

30. The lens of claim 22, wherein said electro-active material has an alterable refractive index and each of said first and second substrates have a fixed refractive index, wherein when an electrical potential is applied below a first predetermined threshold between said first and second electrodes the refractive index of said electro-active material is approximately equal to the refractive index of said first and second substrates.

31. The lens of claim 30, wherein when an electrical potential is applied above a second predetermined threshold between said first and second electrodes the refractive index of said electro-active material is different from the refractive index of said first and second substrates.

32. The lens of claim 31, wherein said difference in refractive indices results in a phase retardation of approximately 2π.

33. The lens of claim 22, further comprising a static refractive optic, wherein said electro-active lens is embedded within said static refractive optic.

34. The lens of claim 33, further comprising adhesive for securing said electro-active lens within said static refractive optic.

35. The lens of claim 33, wherein said static refractive optic is adapted for blocking ultraviolet electromagnetic radiation.

36. The lens of claim 35, wherein said static refractive optic is formed from materials that block ultraviolet electromagnetic radiation.

37. The lens of claim 35, wherein said static refractive optic is coated with materials that block ultraviolet electromagnetic radiation.

38. The lens of claim 22, wherein said electro-active material is a cholesteric liquid crystal material.

39. The lens of claim 22, wherein when said electrical potential is applied between said first and second electrodes using an initial waveform spike in electrical potential at a first voltage followed by a sustained electrical potential waveform at a second relatively smaller voltage.

40. The lens of claim 22, wherein said insulating layer comprises SiO₂.

41. The lens of claim 22, wherein the insulating layer is sufficiently thick for preventing said electrodes from conducting and maintaining the voltage potentials between said electrodes for operating the lens.

42. An electro-active lens, comprising:
a first substrate having a surface relief diffractive topological profile forming a plurality of peaks,
a second substrate having a substantially smooth topological profile positioned opposite said surface relief diffractive topological profile, wherein said substantially smooth topological profile faces said surface relief diffractive topological profile;
a first electrode and a second electrode disposed between said substrates following the topological profiles of said first and second substrates, respectively, wherein said electrodes form a gap therebetween narrowing at said peaks to a distance less than or equal to about 1 micron;
an electro-active material having an alterable optical property positioned between said first and second electrodes; and
a first insulating layer disposed between said first and second electrodes, wherein said first insulating layer has an impedance sufficient for allowing an electrical potential to be applied to said electrodes for altering an optical property of said electro-active material and for preventing electrical conduction between said electrodes at said peaks.

43. The lens of claim 42, further comprising a first alignment layer positioned between said electro-active material and at least one of said first and second electrodes.

44. The lens of claim 42, wherein the impedance of said insulating layer is greater than the impedance of said electro-active material.

45. The lens of claim 42, wherein the difference between the optical path length of light traveling between said electrodes through said smallest distance and a largest distance therebetween is approximately equal to the design wavelength of said lens.

46. The lens of claim 42, wherein said first insulating layer is positioned along said first electrode.

47. The lens of claim 42, wherein said first insulating layer is positioned along said second electrode.

48. The lens of claim 42, further comprising a second insulating layer disposed between said two electrodes, wherein said first insulating layer is positioned along said first electrode and said second insulating layer is positioned along said second electrode.

49. The lens of claim 43, further comprising a second alignment layer, wherein said first alignment layer is positioned between said electro-active material and said first electrode and said second alignment layer is positioned between said electro-active material and said second electrode.

50. The lens of claim 42, wherein said electro-active material has an alterable refractive index and each of said first and second substrates have a fixed refractive index, wherein when an electrical potential is applied below a first predetermined threshold between said first and second electrodes the refractive index of said electro-active material is approximately equal to the refractive index of said first and second substrates.

51. The lens of claim 50, wherein when an electrical potential is applied above a second predetermined threshold between said first and second electrodes the refractive index of said electro-active material is different from the refractive index of said first and second substrates.

52. The lens of claim 51, wherein said difference in refractive indices results in a phase retardation of approximately 2π.

53. The lens of claim 42, further comprising a static refractive optic, wherein said electro-active lens is embedded within said static refractive optic.

54. The lens of claim 53, further comprising adhesive for securing said electro-active lens within said static refractive optic.

55. The lens of claim 53, wherein said static refractive optic is adapted for blocking ultraviolet electro-magnetic radiation.

56. The lens of claim 55, wherein said static refractive optic is formed from materials that block ultraviolet electro-magnetic radiation.

57. The lens of claim 55, wherein said static refractive optic is coated with materials that block ultraviolet electro-magnetic radiation.

58. The lens of claim 42, wherein said electro-active material is a cholesteric liquid crystal material.

59. The lens of claim 42, wherein when said electrical potential is applied between said first and second electrodes using an initial waveform spike in electrical potential at a first voltage followed by a sustained electrical potential waveform at a second relatively smaller voltage.

60. The lens of claim 42, wherein said insulating layer comprises SiO₂.
